(19) United States
(12) Patent Application Publication
(10) Pub. No.: US 2014/0236811 A1
(43) Pub. Date: Aug. 21, 2014

(54) EFFICIENT INTER-BANK FUNDS TRANSFERS

(71) Applicant: Uniloc Luxembourg S.A., Luxembourg (LU)

(72) Inventor: Craig S. Etchegoyen, Plano, TX (US)

(73) Assignee: Uniloc Luxembourg S.A., Luxembourg (LU)

(21) Appl. No.: 14/155,153

(22) Filed: Jan. 14, 2014

Related U.S. Application Data
(60) Provisional application No. 61/765,521, filed on Feb. 15, 2013.

(51) Int. Cl. G06Q 20/10

(52) U.S. Cl. CPC G06Q 20/10
USPC 705/39

(57) ABSTRACT

An inter-bank server maintains accounts in multiple banks and process a funds transfer from one bank to a second bank as two separate intra-bank transfers. The process is started by a bank customer initiating an intra-bank transfer within a first bank to a first inter-bank transfer account maintained by the inter-bank server in the first bank. The inter-bank server determines the amount of the transfer and parses data identifying the intended recipient from data accompanying the intra-bank transfer record. The inter-bank server initiates a transfer to the account of the intended recipient in the second bank from a second inter-bank transfer account maintained by the inter-bank server in the second bank. The amount of the transfer is the amount received in the inter-bank transfer account in the first bank.

This application claims priority to U.S. Provisional Application 61/765,521, filed Feb. 15, 2013, which is fully incorporated herein by reference.

### BACKGROUND OF THE INVENTION

1. Field of Invention

The present invention relates generally to computer data processing and, more specifically, to methods and systems for efficiently and electronically transferring funds between banks.

2. Description of the Related Art

Electronic funds transfers have been around for quite some time. Electronic funds transfers between different banks are effected through the Automatic Clearing House (ACH). ACH processes large numbers of financial transactions each day, including electronic payments, direct deposits, and inter-bank fund transfers.

For intra-bank transfers, each bank can effect the transfers without cooperation of any other institution and, accordingly, tend to have no difficulty in doing so and frequently don't charge for such transfers.

However, for inter-bank transfers, both the sending bank and the receiving bank must “speak the same language”—more accurately must follow a shared protocol—by which the transfer is effected. ACH provides that shared protocol.

Much like shared roads we all drive on to get from one place to another, ACH is a natural monopoly. Accordingly, ACH is free to charge fees that would arguably be significantly less if there were effective competition in inter-bank services. To use ACH, however, each bank must implement its own instance of the shared ACH protocol. Such is a non-trivial task and one that is not likely to be repeated by any bank for a competing inter-bank service. Besides, banks seems perfectly happy to pass ACH fees through to their customers, sometimes adding additional fees to compensate for the effort required to implement an ACH solution at the bank.

What is needed is an alternative inter-bank service that is more efficient that does not require adoption and implementation by banks.

### SUMMARY OF THE INVENTION

In accordance with the present invention, an inter-bank server maintains accounts in multiple banks and process a funds transfer from one bank to another bank as two separate intra-bank transfers. Accordingly, neither of the banks needs to implement any protocol other than their own intra-bank transfers, and both of the intra-bank transfers are free of charge to the customers of both banks.

The accounts maintained by the inter-bank server are sometimes referred to as inter-bank transfer accounts. The inter-bank server transfers funds from a first account in a first bank to a second account in a second bank generally as follows. The process is started by the bank customer owning the first account initiating an intra-bank transfer within the first bank to a first inter-bank transfer account maintained by the inter-bank server in the first bank. The customer identifies an intended recipient of the transfer in data associated with the intra-bank transfer. For example, the customer can include an e-mail address of the intended recipient in a “notes” or “comments” field in the intra-bank transfer request form.

The inter-bank server receives notification of the transfer, e.g., in an e-mail message received from a server of the first bank. The inter-bank server interacts with servers of various banks by emulating a client computer and a human user through a web user interface provided by each of the banks' servers. Thus, the inter-bank server can determine specific details of the first intra-bank transfer in precisely the same way that a human customer of the first bank can.

The inter-bank server determines the amount of the transfer and parses data identifying the intended recipient from the “notes” or “comments” field of the intra-bank transfer record. The inter-bank server stores account and bank information for a number of users and retrieves information specifying the bank and account of the intended recipient as the ultimate destination for the funds transfer. The bank of the intended recipient is the second bank. The inter-bank server also maintains an inter-bank transfer account in the second bank.

The inter-bank server interacts with a server of the second bank to initiate a transfer to the account of the intended recipient in the second bank. The amount of the transfer is the amount received in the inter-bank transfer account in the first bank. In some embodiments, the inter-bank server reduces the amount transferred to take a predetermined fee for facilitating the inter-bank transfer. Any comments or notes from the first intra-bank transfer other than those identifying the intended recipient are retained in the second intra-bank transfer.

This second intra-bank transfer completes the inter-bank transfer. The intended recipient receives the funds in her account as she would from any funds transfer, including receiving an e-mail notification of the transfer if she has set up such notification with the second bank. Since the inter-bank transfer was effected by two intra-bank transfers, no fees from either bank are incurred. In addition, neither bank must implement an inter-bank protocol for there to be a system that can compete with ACH and its natural monopoly.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing multiple bank servers, multiple client devices, and an inter-bank server computer that effects an inter-bank funds transfer between one bank and another in accordance with one embodiment of the present invention.

FIG. 2 is a transaction flow diagram showing effecting of an inter-bank funds transfer between one bank and another by the inter-bank server of FIG. 1.

FIG. 3 is a block diagram of a user record used by the inter-bank server of FIG. 1 to maintain bank and account information of users who can send and receive funds through the inter-bank server.

FIG. 4 is a block diagram of a transaction record used by the inter-bank server of FIG. 1 to represent an inter-bank transfer.

FIG. 5 is a logic flow diagram illustrating the delivery of funds to a user that is not already registered to receive funds through the inter-bank server of FIG. 1.

FIG. 6 is a block diagram showing the inter-bank server of FIG. 1 in greater detail.

### DETAILED DESCRIPTION

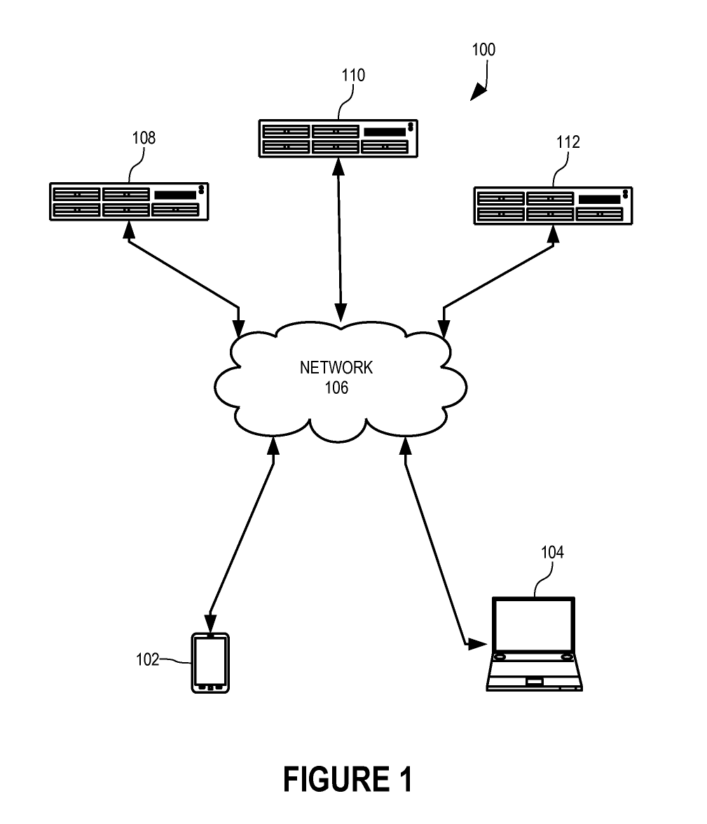

In accordance with the present invention, an inter-bank server 110 (FIG. 1) maintains accounts in both bank servers 108 and 112 to process a funds transfer from bank server 108 to bank server 112 as two separate intra-bank transfers. Accordingly, neither of bank servers 108 and 112 need to implement any protocol other than their own intra-bank transfers, and both of the intra-bank transfers are free of charge to the customers of both banks.

Bank servers 108 and 112 are servers respectively provided by two distinct banks and are conventional. Each provides a web user interface by which customers of the respective banks can manage their accounts with each bank and to request services such as funds transfers and bill payments.

Each of client devices 102 and 104 is a client device used by bank customers to manage respective accounts. In this illustrative example, client device 102 is used by a customer of the bank operating bank server 108, and client device 104 is used by a customer of the bank operating bank server 112.

Inter-bank server 110 is provided and operated by a business entity that has bank accounts in both banks, i.e., accounts represented and managed through each of bank servers 108 and 112.

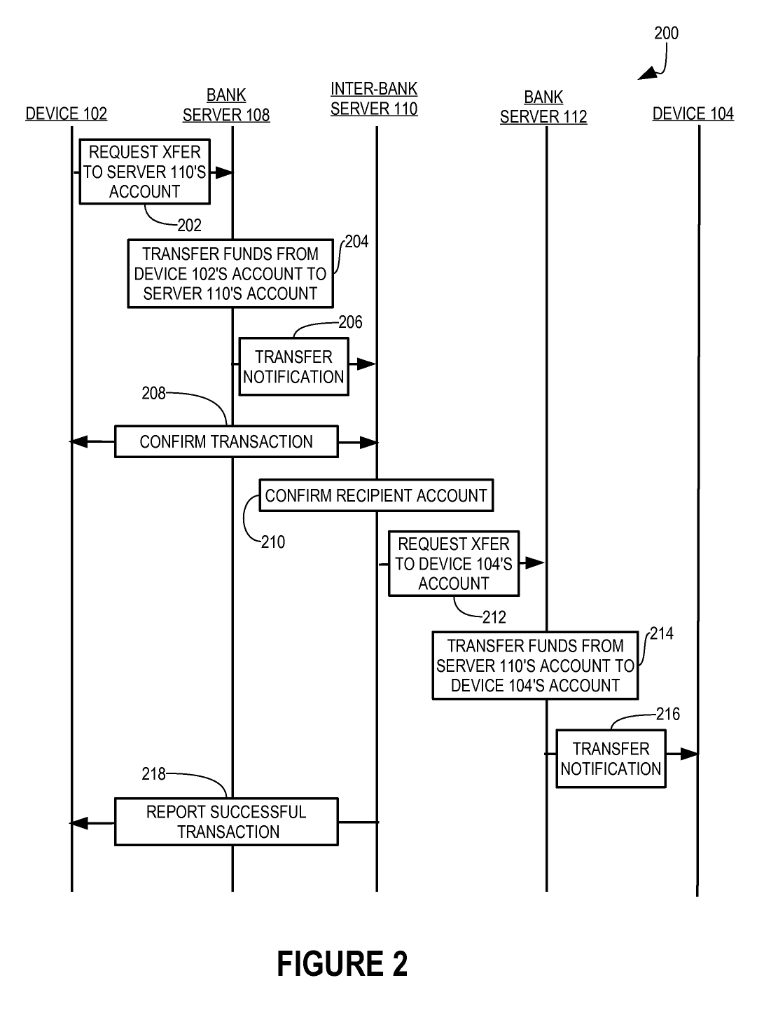

Transaction flow diagram 200 (FIG. 2) illustrates facilitation of a funds transfer by inter-bank server 110. In this illustrative example, the user of client device 102 is transferring funds to the user of client device 104.

In step 202, the user of client device 102 uses a web user interface provided by bank server 108—requiring physical manipulation by the user of client device 102 of one or more user input devices of client device 102—to request a transfer of funds from the user's account to an account within bank server 108 associated with inter-bank server 110. The web user interface provided by bank server 108 provides an opportunity for the user of client device 102 to provide comments and/or notes for the recipient of the transfer of funds. In conventional usage, the user might provide an account number or invoice number to inform the recipient of funds as to the purpose of the transfer. In this example, the user of client device 102 includes an identifier of the ultimate recipient in the comments or notes of the transfer request. The identifier can be an e-mail address, for example, since e-mail addresses are globally unique.

In step 204, bank server 108 effects the transfer to the account of inter-bank server 110 in a conventional manner, including notifying inter-bank server 110 of the transfer in step 206. Many banks allow users to designate an e-mail address for receiving notification of events in their accounts with the bank. In this illustrative example, inter-bank server 110 is associated with such an e-mail address for such notifications.

At this point, the user of client device 102 has already effected transfer of funds to inter-bank server 110 and the transfer took place immediately and without incurring cost from bank server 108.

In step 208, inter-bank server 110 requests confirmation of the transaction by the user of client device 102. The confirmation serves at least two purposes. The first is ensuring that the transfer was indeed intended by the user. The second is that inter-bank server 110 has identified the intended recipient from a textual comment or note composed by the transferring user and the transferring user is provided with the opportunity to confirm that the intended recipient was properly identified.

The request can be an e-mail message sent to an e-mail address associated with the user of client device 102 and can include HTTP links for confirmation and cancellation of the transfer by which the user can communicate to inter-bank server 110 whether the transfer should be effected. Alternatively, the request can be an SMS message sent to a mobile telephone number associated with the user of client device 102 and confirmation can be a reply SMS message received by inter-bank server 110.

If the user does not confirm the transaction, inter-bank server 110 returns the funds to the user of client device 102 by a reverse intra-bank transfer through bank server 108. Conversely, if the user of client device 108 confirms the transfer, processing by inter-bank server 110 transfers to step 210.

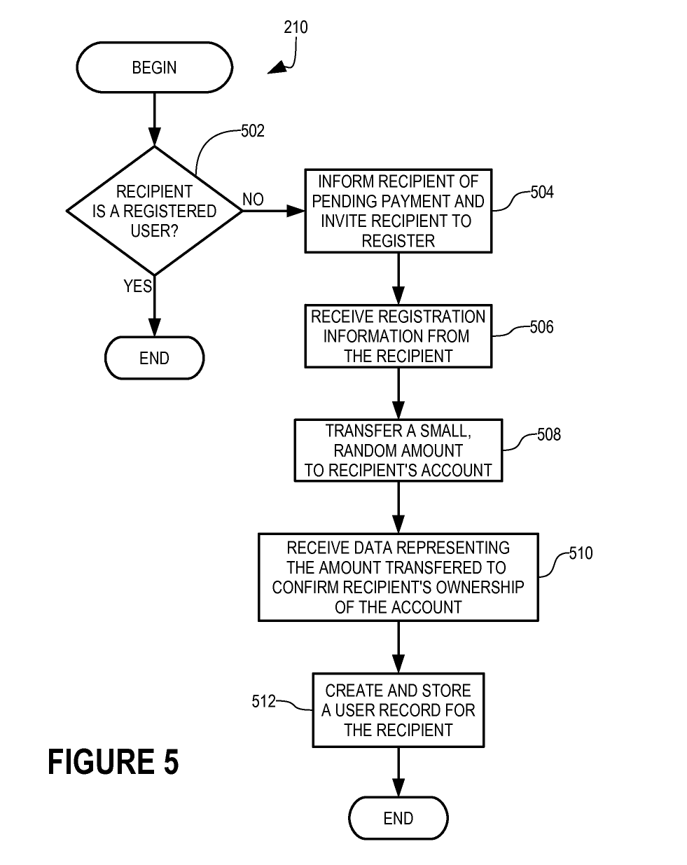

In step 210, inter-bank server 110 confirms that the identified recipient has an account with inter-bank server 110. Step 210 is described in greater detail below in conjunction with logic flow diagram 210 (FIG. 5). Briefly, inter-bank server 110 requires minimal banking information of the recipient user before inter-bank server 110 can effect transfers to the recipient user.

After inter-bank server 108 has confirmed that the intended recipient has provided the requisite banking information in step 210, inter-bank server 110 uses a web user interface provided by bank server 112 to request a transfer of funds from an account within bank server 112 associated with inter-bank server 110 to an account of the user of client device 104 in step 212. In effect, inter-bank server 110 carries out an HTTP dialog with bank server 112 so as to emulate a human user interacting with bank server 112 through a conventional web browser. Inter-bank server 110 therefore effects intra-bank transfers in precisely the manner any human customer of a bank does. Inter-bank server 110 strips the recipient designation from the comment or note of the transfer of step 204 and includes the remainder as a comment or note in the transfer of step 214. As a result, any other information provided by the user of client device 102 in the comments or notes is preserved and forwarded to the user of client device 104.

In response to the request of step 212, bank server 112 effects the transfer of funds from the account of inter-bank server 110 to the account of the user of client device 104 in step 214 and notifies the receiving user in step 216 in a conventional manner.

In step 218, inter-bank server 110 reports successful completion of the funds transfer, effectively providing a receipt to the transferring user of client device 102.

In receiving a transfer of funds in step 204, the balance of the account of inter-bank server 110 within bank server 108 has increased by the amount of the transfer. Similarly, in sending a transfer of funds in step 214, the balance of the account of inter-bank server 110 within bank server 112 has decreased by the amount of the transfer. Over many, many transfers involving both bank servers 108 and 112, it is expected that each bank server will manage accounts of both senders and recipients of funds, resulting in changes in account balances for inter-bank server 110 to be much, much smaller than the total volume of funds transferred.

Even so, if account balances of inter-bank server 110 at various banks become either too high or too low to meet expected demand for inter-bank transfers in the manner described above, inter-bank server 110 can distribute its funds more appropriately using only a single ACH transaction between any two banks periodically (e.g., nightly).

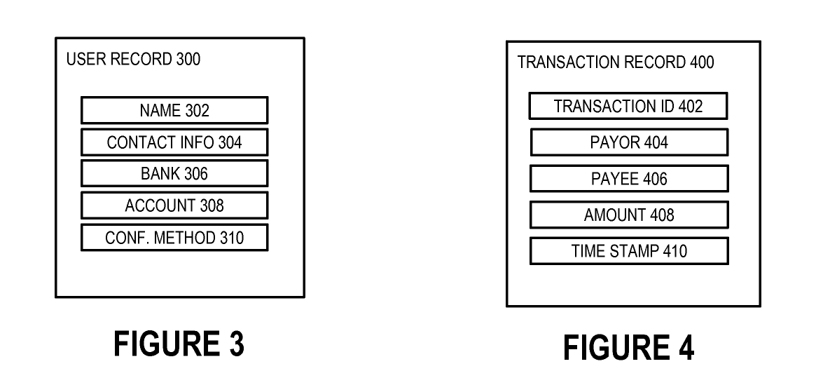

Inter-bank server 110 uses a user record 300 (FIG. 3) to maintain sufficient information about a given user to effect transfers to and from the user in the manner described above. Name 302 stores the name of the user. Contact information 304 stores information by which the user can be contacted regarding transfers involving the user. In this illustrative embodiment, contact information 304 includes an e-mail address of the user and the e-mail address also serves as a globally unique identifier of the user.

Bank 306 specifies the particular bank at which the user holds an account. Inter-bank server 110 uses bank 306 to determine with which of bank servers 108 and 112 to cooperate to transfer funds from or to the user.

Account 308 specifies the account of the user. When inter-bank server 110 receives notification of a transfer receipt in step 206 (FIG. 2), inter-bank server 110 uses the identity of bank server 108 and the sender's account to identify the sending user by matching bank 306 (FIG. 3) and account 308, respectively.

Confirmation method 310 specifies the manner in which the user would like to be asked for transfer confirmation in the manner described in step 208 (FIG. 2). Examples of confirmation methods include a voice call to a telephone number (e.g., “Press 1 to confirm. Press 2 to cancel.”), an SMS text message to a mobile telephone, and an e-mail message giving instructions to confirm or cancel the transaction, e.g., by reply e-mail or through a web user interface.

Inter-bank server 110 also uses transaction records such as transaction record 400 (FIG. 4) to track and record individual transactions. Transaction identifier 402 is an identifier of a given transaction and is unique among identifiers of other transaction records 400. Payor 404 identifies a user record such as user record 300 (FIG. 3) that identifies the payor of the transaction. Payee 406 (FIG. 4) identifies a user record such as user record 300 (FIG. 3) that identifies the payee of the transaction.

Amount 408 specifies the amount of funds transferred and time stamp 410 specifies the date and time of the transfer. In some embodiment, time stamp 410 can be a time-stamped log of events in the carrying out of the funds transfer, including the initiating transfer to inter-bank server 110, confirmation by the payor, and resulting transfer by inter-bank server 110 to the payee.

As noted above, confirmation of the recipients account by inter-bank server 110 in step 210 (FIG. 2) is shown in greater detail as logic flow diagram 210 (FIG. 5).

In test step 502, inter-bank server 110 determines whether the recipient identified by the transfer of step 204 (FIG. 2) is a registered user of inter-bank server 110. In an embodiment in which each user is identified by an e-mail address, inter-bank server 110 searches for a user record for which contact information 304 (FIG. 3) includes the e-mail address by which the intended recipient user is identified.

If inter-bank server 110 finds such a user, processing according to logic flow diagram 210, and therefore step 210 (FIG. 2), completes and inter-bank server 110 determines that the intended recipient is a user that is registered with inter-bank server 110.

Conversely, if inter-bank server 110 finds no such user, processing transfers from test step 502 (FIG. 5) to step 504. In step 504, inter-bank server 110 informs the intended recipient user of the pending transfer of funds and invites the intended recipient user to register with inter-bank server 110. If the intended recipient user declines to register, inter-bank server 110 reverses the transfer of step 204 (FIG. 2) in the manner described above.

Conversely, if the intended recipient user agrees to register, inter-bank server 110 provides a web user interface by which the intended recipient user provides sufficient information to form user record 300 (FIG. 3) for the intended recipient user. Inter-bank server 110 receives that information in step 506 (FIG. 5).

In step 508, inter-bank server 110 transfers a small, randomly selected amount into the account and bank specified by the intended recipient user as bank 306 (FIG. 3) and account 308. For tighter security, inter-bank server 110 can make multiple, small transfers. Randomly selecting amounts from $0.01-$1.00 provides 100 possible values. Two transfers randomly selected from the same range provides 10,000 possible values, making guessing of the amounts highly unlikely. Inter-bank server 110 asks the intended recipient user to enter the amount(s) transferred. Presumably, the user could not ascertain the amount(s) transferred without full access to the account. Thus, if the user accurately identifies the amount(s) transferred into the account in step 510 (FIG. 5), inter-bank server 110 determines that the user is the proper owner of the account identified.

In step 512, inter-bank server 110 creates a user record 300 (FIG. 3) from the information received from the user in step 506 and determines that the intended recipient is a user that is registered with inter-bank server 110. After step 512, processing according to logic flow diagram 210, and therefore step 210 (FIG. 2) completes successfully.

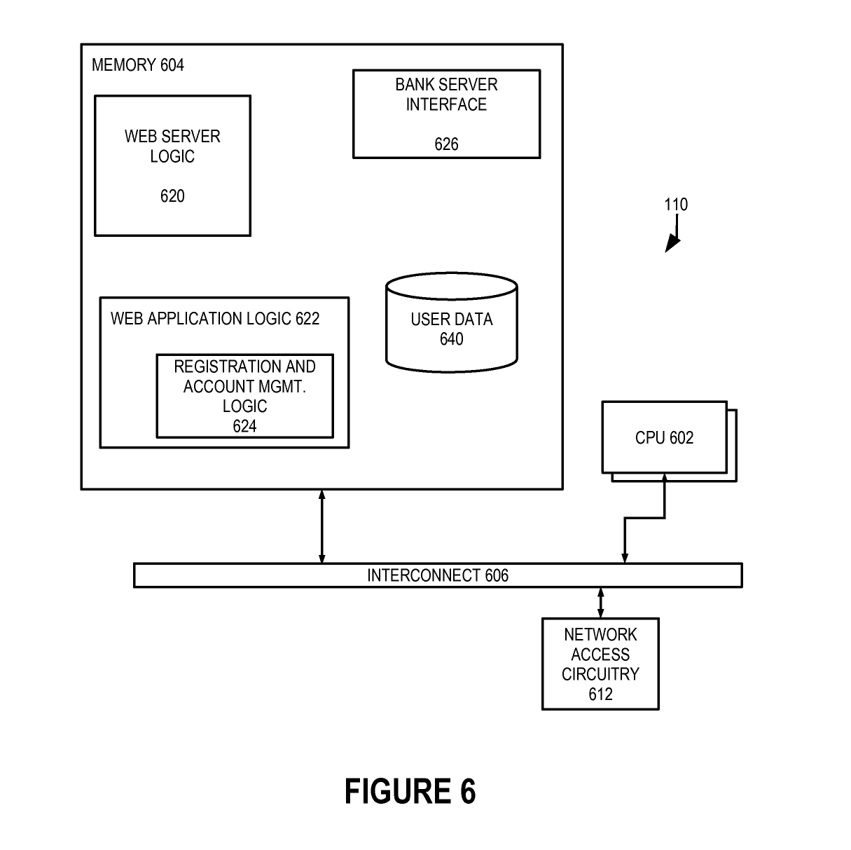

Server computer 106 is shown in greater detail in FIG. 6. Server 106 includes one or more microprocessors 602 (collectively referred to as CPU 602) that retrieve data and/or instructions from memory 604 and execute retrieved instructions in a conventional manner. Memory 604 can include generally any computer-readable medium including, for example, persistent memory such as magnetic and/or optical disks, ROM, and PROM and volatile memory such as RAM.

CPU 602 and memory 604 are connected to one another through a conventional interconnect 606, which is a bus in this illustrative embodiment and which connects CPU 602 and memory 604 to network access circuitry 612. Network access circuitry 612 sends and receives data through computer networks such as wide area network 106 (FIG. 1).

A number of components of server 106 are stored in memory 604 (FIG. 6). In particular, web server logic 620 and web application logic 622, including registration and account management logic 624, are each all or part of one or more computer processes executing within CPU 602 from memory 604 in this illustrative embodiment but can also be implemented using digital logic circuitry. Bank server interface 626 is also all or part of one or more computer processes executing within CPU 602 from memory 604 in this illustrative embodiment but can also be implemented using digital logic circuitry.

Web server logic 620 is a conventional web server. Web application logic 622 is content that defines one or more pages of a web site and is served by web server logic 620 to client devices such as client devices 102 and 104. Registration and account management logic 624 specifies the behavior of server 106 in providing registration and account management services in the manner described above. For example, registration and account management logic 624 provides a user interface through which a user of client device 104 can specify bank and account information for formation of user record 300 (FIG. 3).

Bank server interface 626 (FIG. 6) specifies the behavior of server 106 in interacting with bank servers 108 and 112 in the manner described above. For example, bank server interface 626 can emulate a client device interacting with each of bank servers 108 and 112 through respective web sites provided by each.

User data 640 is data persistently stored in memory 604 and is organized as one or more databases in this illustrative embodiment. User data 640 includes user records such as user record 300 (FIG. 3) and transaction records such as transaction record 400 (FIG. 4).

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A computer-implemented method for facilitating inter-bank transfers of funds, the method comprising:
detecting, at an inter-bank server, a first transfer of funds from a customer account in a first bank to a first inter-bank transfer account in the first bank;
determining, at the inter-bank server, an intended recipient of the funds from data associated with the first transfer of funds;
determining, at the inter-bank server, that the intended recipient has an account in a second bank; and
initiating, by the interbank server, a second transfer of funds from a second inter-bank transfer account in the second bank to the account of the intended recipient in the second bank.

2. The method of claim 1 wherein detecting a first transfer of funds comprises:
receiving notification through a computer network of the first transfer from a first bank server of the first bank.

3. The method of claim 1 wherein determining an intended recipient comprises:
parsing a user identifier of the intended recipient from text associated with the first transfer of funds.

4. The method of claim 1 wherein determining that the intended recipient has an account in a second bank comprises:
notifying the intended recipient that funds are to be transferred to the intended recipient; and
receiving data from the intended recipient that identifies the account and the second bank.

5. The method of claim 1 wherein initiating a second transfer of funds comprises:
sending data through a computer network to a second bank server of the second bank, wherein the data represents a request for the second transfer of funds from the second inter-bank transfer account in the second bank to the account of the intended recipient in the second bank.

6. A tangible computer readable medium useful in association with a computer that includes one or more processors and a memory, the computer readable medium including computer instructions that are configured to cause the computer, by execution of the computer instructions in the one or more processors from the memory, to facilitate inter-bank transfers of funds by at least:
detecting a first transfer of funds from a customer account in a first bank to a first inter-bank transfer account in the first bank;
determining an intended recipient of the funds from data associated with the first transfer of funds;
determining that the intended recipient has an account in a second bank; and
initiating a second transfer of funds from a second inter-bank transfer account in the second bank to the account of the intended recipient in the second bank.

7. The computer readable medium of claim 6 wherein detecting a first transfer of funds comprises:
receiving notification through a computer network of the first transfer from a first bank server of the first bank.

8. The computer readable medium of claim 6 wherein determining an intended recipient comprises:
parsing a user identifier of the intended recipient from text associated with the first transfer of funds.

9. The computer readable medium of claim 6 wherein determining that the intended recipient has an account in a second bank comprises:
notifying the intended recipient that funds are to be transferred to the intended recipient; and
receiving data from the intended recipient that identifies the account and the second bank.

10. The computer readable medium of claim 6 wherein initiating a second transfer of funds comprises:
sending data through a computer network to a second bank server of the second bank, wherein the data represents a request for the second transfer of funds from the second inter-bank transfer account in the second bank to the account of the intended recipient in the second bank.

11. A computer system comprising:
at least one processor;
a computer readable medium that is operatively coupled to the processor;
network access circuitry that is operatively coupled to the processor; and
registration and account management logic (i) that executes at least in part in the processor from the computer readable medium and (ii) that, when executed, causes the processor to facilitate inter-bank transfers of funds by at least:
detecting a first transfer of funds from a customer account in a first bank to a first inter-bank transfer account in the first bank;
determining an intended recipient of the funds from data associated with the first transfer of funds;
determining that the intended recipient has an account in a second bank; and
initiating a second transfer of funds from a second inter-bank transfer account in the second bank to the account of the intended recipient in the second bank.

12. The computer system of claim 11 wherein detecting a first transfer of funds comprises:
receiving notification through a computer network of the first transfer from a first bank server of the first bank.

13. The computer system of claim 11 wherein determining an intended recipient comprises:
parsing a user identifier of the intended recipient from text associated with the first transfer of funds.

14. The computer system of claim 11 wherein determining that the intended recipient has an account in a second bank comprises:
notifying the intended recipient that funds are to be transferred to the intended recipient; and
receiving data from the intended recipient that identifies the account and the second bank.

15. The computer system of claim 11 wherein initiating a second transfer of funds comprises:
sending data through a computer network to a second bank server of the second bank, wherein the data represents a request for the second transfer of funds from the second inter-bank transfer account in the second bank to the account of the intended recipient in the second bank.
